(19) United States
(12) Patent Application Publication
(10) Pub. No.: US 2010/0215895 A1
(43) Pub. Date: Aug. 26, 2010

(54) PROCESS OF PRODUCING ULTRA FINE MICRODENIER FILAMENTS AND FABRICS MADE THEREOF

(75) Inventors: Vikas Madhusudan Nadkarni, Maharashtra (IN); Santosh Raghavendra Huilgol, Maharashtra (IN); Rajiv Kumar, Maharashtra (IN); Manoj Jhaver, Maharashtra (IN); Rupesh Kumar Gupta, Uttar Pradesh (IN)

Correspondence Address: KLEIN, O''NEILL & SINGH, LLP, 18200 VON KARMAN AVENUE, SUITE 725, IRVINE, CA, 92612, US

(73) Assignee: RELIANCE INDUSTRIES LTD., Dist-Raigad, Maharashtra (IN)

(21) Appl. No.: 12/063,416

(22) PCT Filed: Aug. 8, 2006
(86) PCT No.: PCT/IN2006/000295

§ 371 Date: Feb. 8, 2008

(30) Foreign Application Priority Data
Aug. 10, 2005 (IN) 934/MUM/2005

(51) Int. Cl. D01F 8/04; B29C 47/06; D04B 1/16; D03D 15/00; D05C 17/02

(52) U.S. Cl. 428/90; 264/103; 428/221; 442/304; 442/181

(57) ABSTRACT

A process for producing ultramicrodenier filaments evenly distributed in a fabric matrix includes producing bicomponent fibers or filaments using two polymer components; converting the bicomponent fibers or filaments into a fabric; and treating the fabric with an alkali to produce ultramicrodenier filaments of the order of 0.05 to 0.13 denier per filament uniformly distributed in the fabric matrix.

### FIELD OF THE INVENTION

The invention relates to a process for producing ultramicrodenier filaments particularly, of the order of 0.05 to 0.13 denier per filament uniformly distributed in the fabric matrix.

The invention also relates to ultramicrodenier filaments particularly, of the order of 0.05 to 0.13 denier per filament uniformly distributed in the fabric matrix prepared by the above claimed process.

The invention also relates to use of ultramicrodenier filaments to achieving special tactile and visual aesthetic effect in fabrics, which can have differential dyeing effect, excellent softness, drape, high dimensional stability, silky handle/feel, good comfort, weather resistance and easy care properties.

### BACKGROUND OF THE INVENTION

A number of processes are known in the prior art on bicomponent spinning for obtaining very fine filaments from two or more incompatible polymer components, whereby the polymer components may be distributed over the fiber cross section in many different ways. Also various sources have been attempted in the prior art to separate the components of multi component fibers after spinning. JP 2001115337 discloses the component-separable fibers consist of a component comprising alkali-soluble polyesters and a component comprising polyamides and show denier per filament 0.44 dtex on component separation into fibers. A co polyester containing 2.5 mol % sodium 5-sulfoisophthalate units and 13.3 wt. % polyethylene glycol units as one component and nylon 66 as another component were together melt spun. The non-woven web was alkali treated to get the component separation.

JP 2005194681 discloses the conjugate fibers comprising polyester and a polyamide, and have the cross section of the single yarn, cut perpendicular to the length direction of the fiber, showing multiple polyamide segments existing in the polyester component, and have the polyester segment. PET copolymer containing 2.0 mol % 5-sodiosulfoisophthalic acid units and 12.0 wt. % polyethylene glycol units and nylon 6 component containing 0.1% ethylenebis (stearamide) was melt spun. Thus the PET is co polymerized in the invention.

JP 06057537 relates to synthetic conjugate fibers for fabrics with improved drape and softness. The fibers are prepared by melt spinning together a fiber-forming polyester and a co polyester containing 6 mol % sulfonic acid salt units having solubility greater than the polyester to form fibers with a cross section containing 5 segments of PET and having 1 co-Polyester segment in the center.

U.S. Pat. No. 6,767,498 discloses thermally divisible multicomponent fibers characterized by having at least a first component including an elastomeric polymer (e.g., Morthane PS 440-200) and at least a second component including a non-elastomeric polymer (e.g., MRD 5-1442). It also discloses a two-stage process in which two polymers are placed in segmented pie bicomponent geometry, in which one polymer component is elastomeric in nature. The elastomeric and non-elastomeric polymer combination is thermally split due to the differential shrinkage between two incompatible polymers. The multicomponent fibers are useful in the manuf. of nonwoven structures, and in particular nonwoven structures used as synthetic suede and filtration media.

JP 2004285520 discloses the conjugate fibers having the modified cross section showing star-shaped component with 8 lobes and exhibiting number of segments 8. The spun conjugate fibers were immersed in a solution containing benzyl alcohol to split the components. Thus benzyl alcohol may not be feasible commercially.

U.S. Pat. No. 4,364,983 discloses multifilament yarn consisting of single filaments of the multicomponent matrix-segment type where the individual components of the yarn show false twist crimp and where all or parts of the individual component consisting of the matrix and at least three segment fibers split off such matrix, said segment fibers having shrunk by at least 10% in relation to the matrix fiber, are bonded to each other at irregular intervals. The woven, knitted, laid fabric of these filaments are subject to the organic solvent and milling treatment to split the polymer components.

Some of the prior arts disclose the segmented pie bicomponent filaments processed through the staple fiber melt-spinning route for producing non-woven fabrics. These fabrics were split by means of various physical separation methods such as water jet splitting technique, ultrasonic splitting technique, mechanical splitting technique depending upon the polymer combination chosen for the development of the micro fibers as per its application point of view, which is disclosed in U.S. Pat. No. 6,830,809, U.S. Pat. No. 6,696,373, U.S. Pat. No. 6,706,652 and U.S. Pat. No. 4,361,609.

JP 03213555 discloses the Hollow split tables segmented pie bicomponent geometry for the nonwoven fabrics. The polymers are mechanically split to produces microfilaments less than 0.8 denier. It also describes about the partial pilling problem after splitting the filaments below 0.8 denier.

U.S. Pat. No. 6,780,357 discloses the generation of microfilament in the range of 0.05 to 1.5 denier. The polymer combination selected is from the family of Polyester i.e. Poly lactic acid and Polyethylene terephthalate. The water jet splitting technique followed to achieve this range of denier.

JP 2005200786 discloses the conjugate fibers having a component (A) and another polymer component (B) separated into multiple parts by hot water treatment as one of the polymer component consist water-swellable polyether ester polymers. The conjugate fibers are useful for suede like fabrics, clothing, leather substitutes, and wiping cloths. A cross section having radial-shaped with 16 segments, as 8 segments of one polymer and 8 segments of another polymer, and showing component separation amount 100% on treating the fibers with water for 30 min at 80° C. and exhibiting degree of swelling of 42%.

U.S. Pat. No. 403,988 discloses use of the three-segment geometry produce microfilaments. The segments are from the family of Polyamide, polyester and polyolefin's. These are produced through two-stage process.

U.S. Pat. No. 4,118,534 describes the process modification for online development of crimp in side-by-side bicomponent geometry. After generation of crimp it is treated with the caustic solution to develop microfilaments.

U.S. Pat. No. 4,439,487 discloses the development of fully drawn yarn of dumbbell shape cross-section, which consists of two polymers from the family of polyester and polyamide.

JP 2004300651 discloses the conjugated fibers comprise a polyester component and other component such as polyamide, where the ultra fine fibers are produced by splitting the conjugated fibers. The polyesters for conjugated fibers are made by using titanium compound based catalysts and phosphorous and antimony compound in the polyesters for improving fiber splitting without fiber breakage. A woven fabric was prepared using this yarn as the warp and conventional PET yarns as the filling, treated with an aqueous solution containing 49 g/L NaOH for 50 min at 95° C. to dissolve co Polyester, dyed, and heat set 40 s at 170° C. to give a fabric with stiffness (KES method; 10 best, 1 worst) 9.3, drape 8.9, and softness 8.5.

In the prior art various polymers combinations have been disclosed including copolyesters. The elastomeric polymers, which are used in the prior art, may suffer from obvious processing related issues, which may reflect into the aesthetic appeal.

In the prior art various geometries other than a perfect-segmented pie have been demonstrated. A perfect-segmented pie is rather difficult to produce consistently on a commercial scale. In the prior art ‘star’ shaped geometries have demonstrated which split the filaments, which are less than twice the number of segments. The fabric feel may not be as good.

The work in the prior art focuses on the splitting of two components by solvent methods like use of benzyl alcohol. Use of such chemicals on the commercial scale may not be feasible due to cost and environmental concerns. Moreover various other methods such as hydro splitting, mechanical splitting are used for separation which are rather costly and equipments may not be available with the fabric processor.

In the prior art some of the patent focus on the addition of the additive in the polymer segment which split due to the differential swelling process in the hot water.

In the prior art the work has been done on the side-by-side bicomponent filaments with polyester and polyamide polymer components leading to the stretch effect in the yarn. These stretch yarns are treated in the caustic solution to develop microfilaments.

In the prior art very little work has been done to correlate yarn characteristics to fabric aesthetic appeal.

### OBJECTS OF THE INVENTION

An object of the invention is to provide a process for producing ultramicrodenier filaments particularly, of the order of 0.05 to 0.13 denier per filament uniformly distributed in the fabric matrix.

Another object of the invention is to provide a process for producing ultramicrodenier filaments particularly, of the order of 0.05 to 0.13 denier per filament uniformly distributed in the fabric matrix, where the process is simple, easy and convenient to carry out.

Another object of the invention is to provide a process for producing ultramicrodenier filaments particularly, of the order of 0.05 to 0.13 denier per filament uniformly distributed in the fabric matrix, where the process is designed such that the load on effluent in minimal.

Another object of the invention is to provide a process for producing ultramicrodenier filaments particularly, of the order of 0.05 to 0.13 denier per filament uniformly distributed in the fabric matrix where the process is cost-effective.

Yet another object of the invention is to provide ultramicrodenier filaments particularly, of the order of 0.05 to 0.13 denier per filament uniformly distributed in the fabric matrix.

Yet another object of the invention is to provide ultramicrodenier filaments particularly, of the order of 0.05 to 0.13 denier per filament uniformly distributed in the fabric matrix, where the filaments are cost-effective.

Yet another object of the invention is to provide use of ultramicrodenier filaments to achieving special tactile and visual aesthetic effect in fabrics, which can have differential dyeing effect, excellent softness, drape, high dimensional stability, silky handle/feel, good comfort, weather resistance and easy care properties.

### DETAILED DESCRIPTION OF THE INVENTION

According to the invention there is provided a process for producing ultramicrodenier filaments evenly distributed in the fabric matrix, the process comprising producing bicomponent fiber or filament by a single stage process (Fully drawn yarn—FDY) or a two stage process (partially oriented yarn—POY) using two polymer components; converting the bicomponent fibers or filaments into a fabric and treating the fabric with alkali to produce ultramicrodenier filaments particularly of the order of 0.05 to 0.13 denier per filament uniformly or evenly distributed in fabric matrix.

According to the invention there is provided ultramicrodenier bicomponent filament particularly of the order of 0.05 to 0.13 denier per filament uniformly or evenly distributed in matrix of the fabric prepared according to the above process.

Preferably, at least one polymer components of bicomponent fiber or filament is polyester selected from polyethylene terephthalate (PET), polybutylene terephthalate (PBT) or polytrimethylene terephthalate (PTT) or co-polyesters thereof or blends thereof. Preferably, the second polymer component of bicomponent fiber or filament yarn is selected from co-polyesters, polyamide, polyolefin or any fiber forming polymers or blends thereof. Preferably, one of the polymer components of bicomponent fiber or filament may be chemically modified to reduce adhesion between two polymer components. Preferably, the two polymer components of the bicomponent fiber or filament are used in the ratio of 20:80 to 80:20. More preferably, the two polymer components of the bicomponent fiber or filament are used in the ratio of 30:70 to 70:30.

Preferably, the two polymer components of the bicomponent fiber or filament are configured in segmented pie bicomponent geometry. Preferably, the bicomponent fibers or filaments have solid circular or hollow circular cross section.

The selection of the polymer components depends upon the various factors such as intrinsic viscosity, adhesion nature, luster, melt viscosity ratio of the two polymers at their processing temperatures: Preferably, the intrinsic viscosity of polyesters such as PET, PBT or PTT or co-polyesters thereof or blends thereof is in the range of 0.45 to 1.20, more preferably 0.52 to 0.92 and relative viscosity of polyamide such as Nylon or polyolefin or any fiber forming polymers is in the range of 2.0 to 2.8, more preferably 2.1 to 2.4. The ratio of melt viscosity of both the polymers should be in the similar range at the time of extrusion/melt spinning process.

Preferably, the luster combination of the two polymers is semi dull, bright semi dull or any combination thereof.

According to the present invention the two different polymers follow different flow paths from the extruder to the capillary inlet, arranging themselves into a form of a number of alternate segments of the two neighboring polymers in solid segmented pie or hollow segmented pie in solid circular or hollow cross section. The number of segments in the bicomponent ‘segmented pie’ geometry could be between the range of 8 to 32, where the number of segments from each polymer form half of the total number of segments and the individual segments of the two polymers are arranged in alternate manner. The melt viscosity ratio of the two polymers during filament extrusion was controlled so as to achieve perfect shapes of all segments merging into a single central point, without encircling or encapsulation of any one-polymer segment by the other polymer. Thus one gets a perfect segmented pie cross section. The melt temperatures of two polymers were controlled along their respective flow paths to get a perfect or near perfect segmented pie geometrical cross section distribution of the two polymers. The process parameters were adjusted to achieve consistency of various segmented pie geometrical cross sections and minimum adhesion of the two polymers along the length of the yarn.

Preferably, the single stage process (Fully drawn yarn—FDY) comprising extruding two polymer components in separate extruders and passing through the pack towards the capillary to obtain bicomponent fiber or filament having solid circular or hollow circular cross-section; quenching the fiber or filament at quenching zone at temperature in the range of 14° C. to 25° C.; spinning the fiber or filament at speed in the range of 1000 to 2500 meters per minute; passing the yarn over a pair of draw rollers heated between 60° C. to 180° C.; drawing the yarn at speed in the range of 3300 to 5000 meters per minute and winding the yarn on bobbins at speed in the range of 3300 to 5000 meter per minute to obtain fully drawn yarn.

The draw was maintained in the range of 1.5 to 3.1 depending upon the winding speed, denier per filament, polymer combination and the mass contribution of polymers in the segmented pie geometry of the bicomponent fibers or filaments. In this process, the filaments were drawn and heat set on a set of rollers, followed by controlled relaxation prior to winding of yarn over the bobbin. The final mechanical properties of the bicomponent filaments achieved in single stage process are comparable to the homo polymer FDY required for further processing into fabric stage.

Preferably, the two stage process (partially drawn yarn—POY) comprising extruding the two polymers in separate extruders and passed through the pack towards the capillary to obtain bicomponent fiber or filament having solid circular or hollow circular cross-section; quenching the fiber or filament at quenching zone at temperature in the range of 14° C. to 25° C.; spinning the fiber or filament at speed in the range of 2500 to 3500 meters per minute; passing the yarn over cold godets after suitable spin finish application and winding the yarn on the bobbins in the speed range of 2500 to 3500 mpm to produce a partially oriented yarn.

The spinning speed of the partially oriented yarn is at least 2500 m/min; preferably 2900-3300 m/min. The required product attributes like draw tension, residual elongation and natural draw ratio were achieved by optimizing melt spinning process conditions e.g. spinning speed, melt temperature, quenching conditions, etc. The winding tension was maintained in such a manner that the yarn can be easily unwound in the downstream process.

The polymers are directly fed from the outlet of the finisher vessel from the continuous polymerizer or chips of two polymers fed to the extruder. The delustrant is added to polymer components before extrusion to reduce the luster of a manufactured fibers/filaments. The delustrant is present in the polymers is in the range of 0% to 2.5% on weight of that respective polymer.

Preferably, the partially oriented yarn is processed by friction texturing or air texturing route by single end texturing or co-texturing methods or draw-twisting machine to achieve the final properties comparable to homo-polymer yarns comparably processed. The partially oriented yarn was draw textured to obtain yarn to enhance the bulk. The yarn was passed through the primary heater in the temperature range of 150 to 190° C. depending upon the several factors including the processing speed; heater length and heat transfer method like direct contact or convection. The bicomponent yarn can be successfully textured using the disc materials ranging from ceramic to polyurethane. The POY was drawn at the draw ratio ranging from 1.5 to 2.0 depending upon the characteristics of the POY and final targeted properties. Tenacity and elongation response to draw ratio is similar as compared to the conventional homo PET filaments. The texturing speeds were in the range of 300 to 900 m/min.

The doubling of high shrinkage yarn and bicomponent yarn is carried out over the draw texturing or draw-twisting machine. The shrinkage level of the high shrinkage yarn is between the range of 20 to 40%. This type of combination gives excellent feel and texture in the finished fabrics.

The yarn is processed by air texturing route by single end texturing or co-texturing methods. The segmented pie yarn is processed over the parallel type air-texturing machine with or without the combination of other yarns such as stretch yarns, high shrinkage yarns. The texturing speeds are in the range of 300 to 900 m/min. The resultant yarn consists of high bulk, soft feel of natural fibers.

The partially oriented bicomponent yarn is also processed through draw twisting route apart from false twist texturing process. The fibers or filaments is passed over the heated rollers within the temperature range of 100 to 150° C. The draw ratio is adjusted but not limited to in the range of 1.2 to 1.8 depending upon the required final characteristics. The fibers or filaments is passed over a heater plate for heat setting the yarn. The fibers or filaments can also be also doubled with another yarn having different shrinkage properties to provide bulk into the fabric. The speed of draw twisting machine was in the range of 400 to 1000 m/min. Preferably, the partially oriented yarn is processed through false-twist texturing process in the range of 400 to 800 mpm take-up speeds.

The fully drawn yarns or textured yarns are optionally twisted before processing into fabrics. Preferably, the fully drawn yarns are twisted in ‘S’ or ‘Z’ direction in the range of 200 to 2700 turns per meter and heat set in the temperature range of 80° C. to 95° C. with or without use of vacuum in single or multiple cycles before further processing.

Preferably, fabric is produced in various forms such as knitted, woven, nonwoven and tuffed fabrics from the bicomponent fibers or filaments of the invention. Preferably, the fabric is knitted, woven, nonwoven or tufted fabrics.

Preferably, the fabric comprises bicomponent fibers or filaments of the invention in the range of 30% to 100%. The fabric of the invention comprising other yarn of polyester or cotton or wool or viscose or blends thereof is in the range of 1 to 70%.

The yarn is used in either warp or weft or in both directions in the various proportions and in combination with the high shrinkage or stretch yarn to develop the special attributes such as good softness, good moisture management and natural feel.

Preferably the fabric comprising bicomponent fiber or filament is treated with 2% to 10% of alkali at temperature in the range of 80° C. to 130° C. for the residence time of 10 min to 60 min to obtain ultramicrodenier bicomponent filament, particularly of the order of 0.05 to 0.13 denier per filament uniformly and evenly distributed in the fabric matrix. The alkali treatment separates the segments of two polymer components in the solid and hollow segmented pie bicomponent geometry and obtain fabric with the weight loss in the range of 5% to 40% depending upon the fabric construction, twist level and the feel of the finished fabric required.

According to the present invention, the optimized concentration levels of caustic required for effective splitting in the fabric ranged from 3 to 7% and the loss of the weight of the fabric was in the range of 5 to 40%. The temperature maintained in the alkaline bath was in the range of 80 to 100° C. for lower loss in weight and higher extent of splitting without severe damage to the filament cross section. Shrinkage of the fabric was controlled in the range of 7 to 12% during the splitting process.

The fabric after chemical treatment have differential dyeing effects like mélange, good pilling resistance, good abrasion resistance, good drapability, excellent smoothness, softness or silk like touch, etc

In the invention the segmented pie bicomponent fibers or filaments used as the pile in the piled fabric to enhance the moisture management properties. The key area of application is in towels, seat covers, upholstery etc.

In the invention the fabric produced of bicomponent segmented pie fibers or filaments is treated in the alkaline bath to split the polymer components in the alternate segments of the bicomponent geometry.

According to the present invention, the effective splitting was achieved by alkali splitting technique. The splitting conditions like alkali concentration; time and temperature were optimized to get perfect splitting on one hand and minimum weight loss or filament damage on the other. The fabric on alkali treatment can have splitting of between the two polymer components within the different bicomponent geometry in the range of 95 to 100%.

The alkali treated fabric have differential dyeing effects. Differential dyeing effects is generated in the fabric during dyeing. With the careful selection of the dyes for the two different polymers special effects like mélange is obtained. They can be dyed with disperse dyes in single bath or a combination of acid and disperse dyes in single or double bath method to get novel effects like mélange, cross dyed etc. The reduction clearing treatment of the fabric is different from the normal homo PET polymers as the behavior of the polymers from different class differs in the response with respect to the reduction clearing process conditions. In the present invention the dyeing temperature required to dye the split yarn is lower than the dyeing temperature of PET preferably in the range of 110 to 130° C. with good color fastness properties of the fabric.

The various fabric attributes such as bending stiffness, tensile properties, wicking properties, drying rate and water retention capacity were evaluated before and after splitting process. The split filaments of the two polymers provide excellent fabric attributes, such as, greater bulk, good stretch, high cover, excellent softness, drape, high dimensional stability, silky handle, good comfort, water vapors permeability, weather resistance and easy care properties.

The knitted or woven fabric comprising ultramicrodenier filaments have good pilling resistance, abrasion resistance and drapability. The knitted or woven fabric comprising ultramicrodenier filaments have excellent smoothness, softness and silk like touch. The knitted or woven fabric comprising ultramicrodenier filaments have fastness properties comparable to the normal unsplitted fabric.

The fabric produced from bicomponent segmented pie yarn according to the invention used as filler yarn with the high stretch yarn and high shrinkage yarn to induce the special attributes such as softness, bulk in the fabric.

The cross sectional configuration used in the invention is a perfect segmented pie. A perfect-segmented pie is rather difficult to produce consistently on a commercial scale; which has been successfully demonstrated in the invention. A process for producing ultramicrodenier filaments particularly, of the order of 0.05 to 0.13 denier per filament uniformly distributed in the fabric matrix is simple, easy and convenient to carry out as the spinning is carried out at commercial speeds, fabric formation is as per standard technique and splitting conditions are mild. A treatment process for producing ultramicrodenier filaments particularly, of the order of 0.05 to 0.13 denier per filament uniformly distributed in the fabric matrix does not use organic and volatile solvents and generates minimum effluent during the splitting process. A process for producing ultramicrodenier filaments particularly, of the order of 0.05 to 0.13 denier per filament uniformly distributed in the fabric matrix is cost-effective as the spinning is carried out at commercial speeds and larger amount of standard polyester used. Ultramicrodenier filaments particularly, of the order of 0.05 to 0.13 denier per filament uniformly distributed in the fabric matrix are cost-effective as no separate hardware is required for downstream and splitting can be carried out in standard dyeing machine and uses low concentration alkali to split the segments.

Although the invention has been described with reference to specific examples, it will be appreciated by those skilled in the art that the invention may be embodied in many other forms.

### Example 1

PET and Nylon 6 were melt processed through bicomponent spinning machine to configure the polymers in segmented pie geometry comprising sixteen segments; eight alternate segments of polyester and polyamide. The weight ratio of PET to Nylon6 polymer in the bicomponent fiber was 70:30. The filaments were processed through the single stage process route to get a set yarn. The fabric produced by using this yarn was subjected to the chemical treatment, which results into the splitting of each filament into the ultrafine microfilaments.

Single stage process: PET and Nylon 6 chips were extruded separately and passed through the pack comprising filter and distribution plates so as to obtain filaments having segmented-pie cross sectional geometry. The yarn was passed over the heated godet roller I at the temperature of 80° C. and drawn at the draw ratio of 2.5 at winding speed of 4500 m/min. The yarn was annealed over the godet roller II at temperature of 155° C. The FDY process conditions are summarized in Table-I. The properties of fully drawn bicomponent yarn are shown in table II. The fabric comprising bicomponent yarn was chemically treated at the temperature of 85° C. for 30 min for splitting the individual polymer segments of each filament of the bicomponent yarns. The chemical Treatment conditions for the knit fabric for splitting of individual polymer segments in each filament of the yarns is given in Table III.

TABLE I
FDY Process Conditions

| Sr. No. | Parameter | Unit | Value |
|---|---|---|---|
| 1 | Denier/No. of filaments | — | 75/36 |
| 2 | Spinning Speed | m/min | 1821 |
| 3 | Godet Roll I Temperature | ° C. | 80 |
| 4 | Godet Roll II Temperature | ° C. | 155 |
| 5 | Draw ratio | — | 2.5 |
| 6 | Winding Speed | m/min | 4500 |

TABLE II
Physical properties of bicomponent FDY

| Sr. No. | Property | Unit | Value |
|---|---|---|---|
| 1 | Tenacity | gpd | 4.21 |
| 2 | Elongation | % | 28.14 |
| 3 | Boiling Water Shrinkage | % | 5.27 |
| 4 | Uster | % | 1.6 |
| 5 | Finish on yarn | % | 1.18 |

TABLE III
Chemical Treatment conditions for the knit fabric for splitting
of individual polymer segments in each filament of the yarns.

| Sr. | Splitting Condition | Unit | Value |
|---|---|---|---|
| 1 | Temperature | ° C. | 85 |
| 2 | Time | min | 30 |
| 3 | Alkali Concentration | % | 5 |
| 4 | Weight Loss | % | 12 |

After chemical treatment, the fabric was consisting of 0.07 to 0.13 denier/filament uniformly distributed in the matrix (measured by SEM image and calculations).

### Example 2

PET and Nylon 6 were melt processed in bicomponent ‘hollow’ segmented pie cross section consisting of sixteen segments, having eight alternate segments of polyester and eight alternate segments of polyamide. The weight ratio of PET to Nylon6 polymer in the bicomponent fiber was 70:30. The filaments were processed through the single process according to Example 1 to get a set yarn. The process conditions of FDY process are shown in Table IV. The physical properties of fully drawn bicomponent yarn are shown in Table V. After knitting into fabric followed by treatment under the splitting conditions are shown in Table VI.

TABLE IV
FDY Process Conditions

| Sr. No. | Parameter | Unit | Value |
|---|---|---|---|
| 1 | Denier/No. of filaments | — | 75/36 |
| 2 | Spinning Speed | mpm | 1620 |
| 3 | Godet Roll I Temperature | ° C. | 83 |
| 4 | Godet Roll II Temperature | ° C. | 155 |
| 5 | Draw ratio | — | 2.5 |
| 6 | Winding Speed | m/min | 4000 |

TABLE V
Physical properties of bicomponent FDY

| Sr. No. | Property | Unit | Value |
|---|---|---|---|
| 1 | Tenacity | gpd | 3.87 |
| 2 | Elongation | % | 36.3 |
| 3 | Boiling Water Shrinkage | % | 4.7 |
| 4 | Uster | % | 2.56 |
| 5 | Finish on yarn | % | 1.48 |

TABLE VI
Splitting conditions i.e. alkali treatment for knit fabric for splitting
of individual polymer segments in each filament of the yarns

| Sr. No. | Splitting Condition | Unit | Value |
|---|---|---|---|
| 1 | Temperature | ° C. | 100 |
| 2 | Time | min | 30 |
| 3 | Alkali | % | 1.5 |
| 4 | Weight Loss | % | 6.2 |

After chemical treatment, the fabric was consist of 0.07 to 0.13 denier/filament uniformly distributed in the matrix (measured by SEM image and calculations).

### Example 3

PET and Nylon 6 were melt processed in bicomponent segmented pie cross section consisting of sixteen segments, having eight alternate segments of polyester and eight alternate segments of polyamide. The weight ratio of PET to Nylon 6 polymer in the bicomponent fiber was 70:30. The filaments were processed through the two-stage process route to get a POY yarn and then it is texturised to get set yarn.

PET and Nylon 6 chips were extruded separately and passed through the pack comprising filter and distribution plates so as to obtain filaments having segmented-pie cross sectional geometry. The yarn was passed over the cold godets at a speed of 2850 m/min and the yarn was wound on the bobbins after passing over the second godet roller. The POY bobbins were then fed to the texturing machine wherein the yarn was passed over a heater at temperature of 140 to 190° C., cooling zone, texturing discs, which impart the necessary twist, which was then removed in the subsequent stage thus imparting bulk to the yarn. The yarn was drawn between the two rollers and simultaneously texturised. The drawn yarn was then set on a second heater followed by cooling zone. The yarn was then wound on the bobbins at a speed of 300 m/min. The process conditions of POY process are shown in Table VII. The physical properties of partial oriented bicomponent yarn are shown in Table VIII.

TABLE VII
POY Process Conditions

| Sr. No. | Parameter | Unit | Value |
|---|---|---|---|
| 1 | Denier/No. of filaments | — | 130/36 |
| 2 | Quench air temperature | ° C. | 19 |
| 3 | Spinning Speed | m/min | 2850 |

TABLE VIII
Physical properties of bicomponent POY

| Sr. No. | Property | Unit | Value |
|---|---|---|---|
| 1 | Tenacity | gpd | 2.28 |
| 2 | Elongation | % | 134.0 |
| 3 | Draw Tension | gm | 44.1 |
| 4 | Uster | % | 1.19 |
| 5 | Finish on yarn | % | 0.24 |

The textured yarn was then converted into fabric form. The fabric was chemically treated according to example 1.

After chemical treatment, the fabric was consisting of 0.07 to 0.13 denier/filament uniformly distributed in the matrix (measured by SEM image and calculations).

### Example 4

The fully drawn segmented Pie filament yarn as produced according to Example 1 was knitted on a circular knitting machine to obtain fabric. The knitted fabric was then splitted by alkali treatment at 100° C. for 30 minutes using 2% alkali solution. The pilling resistance of control (unsplit) and splitted fabric sample was carried out by ICI method for pilling resistance (Method: BSEN ISO 12945-1).

### ICI Pilling Testing Results:

| | | Untreated (Control) | Treated (splitted & |
|---|---|---|---|
| | No. of | Sample | dyed) Sample |
| Duration | Cycles | Pilling Rating* | Pilling Rating* |
| 1 Hr. | 3600 | 5 | 5 |
| 3 Hr. | 10800 | 4-5 | 4 |
| 5 Hr. | 18000 | 4-5 | 4 |
| (final) | | | |

*Rating is done at a scale of 1-5. 5 being No Pill, while 1 being highly pilled sample.
The pilling resistance of the splitted fabric found satisfactory after 18000 cycles with rating of 4 against a rating of 4-5 for control sample.

### Example 5

The woven fabric was produced by using 150/34 polyester yarn as a weft and 75/36 FDY segmented pie yarn (as produced according to Example 1) as a warp. The fabric was treated with alkali, 5% NaOH solution, at the temperature of 85° C. for the duration of 30 min to generate microfilaments. The fabric density was 0.4 g/cm³ after splitting treatment. The tactile attributes of the fabric were analyzed with Kawabata evaluated method (KES-F). The fabric comprised splittable yarn exhibited excellent smoothness, softness and silk like touch, the results of the same are shown in table IX.

TABLE IX
Tactile attributes of the woven fabric with KES-F Method

| Nylon/PET segmented pie woven fabric | | | Value |
|---|---|---|---|
| Hand | Koshi | (Stiffness) | 4.34 |
| Value (HV) | Numeri | (Smoothness) | 7.13 |
| | Fukurami | (Fullness and | 4.94 |
| | | Softness) | |
| | Sofutosa | (Silk like feel and | 6.24 |
| | | Touch) | |

### Example 6

A knitted fabric was prepared of 75/36 fully draw segmented pie yarn (produced according to example 1) and followed by treatment with alkali similar to the conditions as employed in example 1

The knitted fabric of ultra fine microfilament was dyed with 3% shade at 120° C. for 50 min. After reduction clearing colourfastness of the fabric was measured and rated in the range of 4 to 5.

The wash fastness was evaluated as per the ISO method-III and staining on Nylon and polyester was rated in the range of 4-5. The heat fastness properties was determined with sublimation fastness tester at 160 and 180° C. and rated in the range of 4 to 5.

1-23. (canceled)

24. A process for producing a fabric matrix of ultramicrodenier filaments evenly distributed in the matrix, the process comprising:
producing bicomponent fiber or filament using two polymer components:
converting the bicomponent fiber or filament into a fabric: and
treating the fabric with an alkali to produce ultramicrodenier filaments of the order of 0.05 to 0.13 denier per filament uniformly distributed in the fabric matrix.

25. The process of claim 24, wherein at least one polymer component of the bicomponent fiber or filament is a polyester selected from the group consisting of poly-ethylene terephthalate, poly-butylene terephthalate, poly-tetramethylene terephthalate, and blends thereof.

26. The process of claim 24, wherein at least one polymer component of the bicomponent fiber or filament is selected from the group consisting of co-polyester, polyamide, polyolefin, any fiber forming polymers, and blends thereof.

27. The process of claim 24, wherein one of the polymer components of bicomponent fiber or filament is chemically modified to reduce adhesion between the two polymer components.

28. The process of claim 24, wherein the two polymer components of the bicomponent fiber or filament are used in a ratio of 20:80 to 80:20.

29. The process of claim 24, wherein the two polymer components of the bicomponent fiber or filament are configured in segmented pie bicomponent geometry.

30. The process of claim 24, wherein the bicomponent fiber or filament has a circular cross section.

31. The process of claim 24, wherein the bicomponent fiber or filament is produced by a single stage process, wherein the single stage process comprises:
extruding the two polymer components in separate extruders and passing the extruded polymer components through a pack towards a capillary to obtain a bicomponent fiber or filament having a circular cross-section;
quenching the fiber or filament at a quenching zone at a temperature in the range of 14 to 25° C.;
spinning the fiber or filament at a speed in the range of 1000 to 2500 meters per minute to form a yarn;
passing the yarn over a pair of draw rollers heated to a temperature between 60° C. to 180° C.;
drawing the yarn at a speed in the range of 3300 to 5000 meters per minute: and
winding the yarn on bobbins at a speed in the range of 3300 to 5000 meters per minute to obtain fully drawn yarn.

32. The process of claim 24, wherein the bicomponent fiber or filament is produced by a two stage process, wherein the two stage process comprises:
extruding the two polymer components in separate extruders and passing the extruded polymer components through a pack towards a capillary to obtain a bicomponent fiber or filament having a circular a cross-section;
quenching the fiber or filament at a quenching zone at a temperature in the range of 14 to 25° C.;
spinning the fiber or filament at a speed in the range of 2500 to 3500 meters per minute to form a yarn;
passing the yarn over cold godets after a spin finish application: and
winding the yarn on the bobbins at speed in the range of 2500 to 3500 meters per minute to produce a partially oriented yarn.

33. The process of either of claim 31 or 32, wherein the polymer components are directly fed from an outlet of a finisher vessel from a continuous polymerizer.

34. The process of either of claim 31 or 32, wherein the polymer components are directly fed from an outlet of a finisher vessel as chips fed to an extruder.

35. The process of claim 31, wherein the fully drawn yarn is twisted before processing into fabrics.

36. The process of claim 32, wherein the partially oriented yarn is processed through a process selected from the group consisting of friction texturing, air texturing, and draw twisting.

37. The process of claim 24, wherein the bicomponent fiber or filament is converted into fabric by a process selected from the group consisting of knitting, weaving, and tufting.

38. The process of claim 24, wherein the fabric comprising the bicomponent fiber or filament is treated with 2% to 10% of alkali at a temperature in the range of 80° C. to 130° C. for a residence time of 10 to 60 minutes to obtain a filament of the order of 0.05 to 0.13 denier uniformly distributed in the fabric.

39. Ultramicrodenier bicomponent filaments of the order of 0.05 to 0.13 denier uniformly distributed in a fabric matrix prepared according to the process of claim 24.

40. The ultramicrodenier bicomponent filaments of claim 39, wherein at least one polymer component of the bicomponent fiber or filament is a polyester selected from a group consisting of polyethylene terephthalate, polybutylene terephthalate, polytetramethylene terephthalate, and blends thereof.

41. The ultramicrodenier bicomponent filaments of claim 39, wherein at least one polymer component of the bicomponent fiber or filament is selected from a group consisting of co-polyester, polyamide, polyolefin, any fiber forming polymers, and blends thereof.

42. The ultramicrodenier bicomponent filaments of claim 39, wherein one of the polymer components of bicomponent filament is chemically modified to reduce adhesion between the two polymer components.

43. The ultramicrodenier bicomponent filaments of claim 39, wherein the two polymer components of the bicomponent fiber or filament are used in a ratio of 20:80 to 80:20.

44. The ultramicrodenier bicomponent filaments of claim 39, wherein the two polymer components of the bicomponent fiber or filament are configured in a segmented pie bicomponent geometry.

45. The ultramicrodenier bicomponent filaments as claimed in claim 39, wherein the bicomponent fiber or filaments have a circular cross-section.

46. A fabric comprising ultramicrodenier bicomponent filaments of the order of 0.05 to 0.13 denier per filament uniformly distributed in a matrix as prepared according to the process of claim 24.

47. The fabric of claim 46, wherein at least about 30% of the fabric comprises the bicomponent fiber or filament.

48. The fabric of claim 46, wherein the filaments are formed into the fabric by a process selected from the group consisting of knitting, weaving, tufting.
